(19) United States
(12) Patent Application Publication
(10) Pub. No.: US 2007/0103582 A1
(43) Pub. Date: May 10, 2007

(54) PSP video conversion device

(75) Inventor: William Chen, Hsin Tien City (TW)

Correspondence Address: TROXELL LAW OFFICE PLLC, SUITE 1404, 5205 LEESBURG PIKE, FALLS CHURCH, VA, 22041, US

(73) Assignee: Q-Mark Technology Corp.

(21) Appl. No.: 11/269,720

(22) Filed: Nov. 9, 2005

(51) Int. Cl. H04N 5/225

(52) U.S. Cl. 348/373

(57) ABSTRACT

The present invention is related to a PSP video conversion device, which uses a video capture camera (CMOS, CCD module) and convert and output the video on LCD screen through AV cable to a large video display like TV or computer screen. Besides, an audio line is used to capture audio signal at the earphone port on PSP console. A control circuit is also used to integrate and output a set of video and audio signals through an AV cable to a large display.

### BACKGROUND OF THE INVENTION

1. Field of the Invention

The present invention is related to a PSP video conversion output technology. Particularly, the technology can capture video on PSP LCD screen directly through camera (CMOS, CCD module) and output audio signal to a conversion device through an audio line. In such way, the video can be displayed on large TV or computer screen. The device not only provides protection for eyes, but also enhances entertaining and reality effect for gaming.

2. Description of the Prior Art

Currently, the popular PSP (SONY portable handheld gaming machine) is designed to be light, thin, short and small with a LCD screen. Most PSP users are teenagers or even young children. Because the LCD screen is not large and bright enough, and the words on the screen are also small, it is easy for eyes to get tired or lose vision. Therefore, how to effectively improve the situation is the goal the gaming industry is trying to achieve.

Further, because today's video gaming consoles have multiple functions as well as stereo sound effect and high quality picture, teenaged or young players can easily experience the virtual reality through special video and audio effects, which certainly add fun and attractiveness to the game. However, the LCD screen on PSP seems to be insufficient to support the special video and audio effects. Further improvement is expected on its structure.

The inventor found the LCD screen on handheld gaming machine is not desirable and its small size lacks entertaining effect during gaming process. The small screen also tends to cause fatigue and vision reduction for eyes. The inventor with many years of professional knowledge and experience actively sought solutions and finally developed a PSP video conversion device that can simply capture video from PSP screen to large screen. Without a doubt, the invention will benefit our children for keeping good vision.

### SUMMARY OF THE INVENTION

The primary objective for the invention id to provide a PSP video conversion device, which uses a video capture technology (CMOS, CCD module) to convert and output the video on LCD screen to a large video display (TV or computer screen) with improved picture resolution. Besides, an audio line is used to capture audio signal at the earphone port on PSP console. A control circuit is also used to integrate and output a set of video and audio signals through an AV cable to a large display. In such way, the vision of young game players can be protected while enhanced reality and entertaining effect is provided.

To further explain the objectives, functions and features for the invention, a preferred embodiment is provided with illustration as follows:

### DETAILED DESCRIPTION OF THE PREFERRED EMBODIMENT

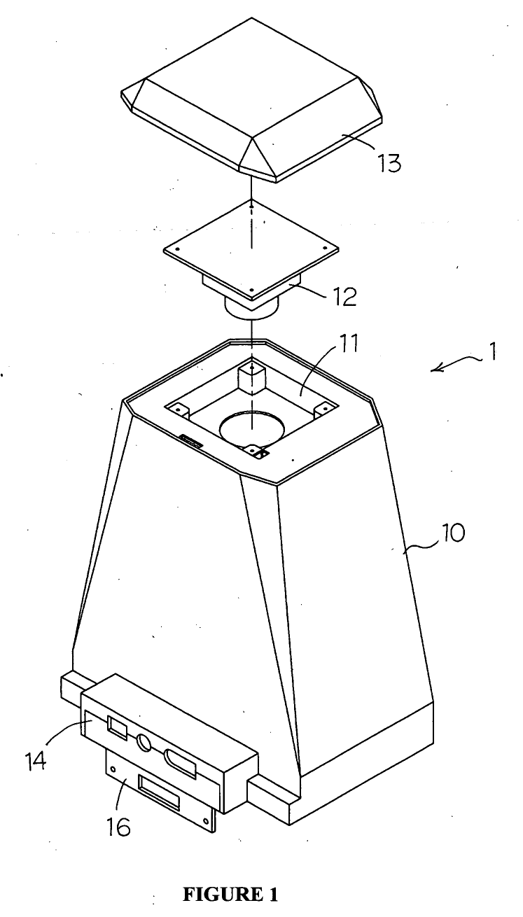

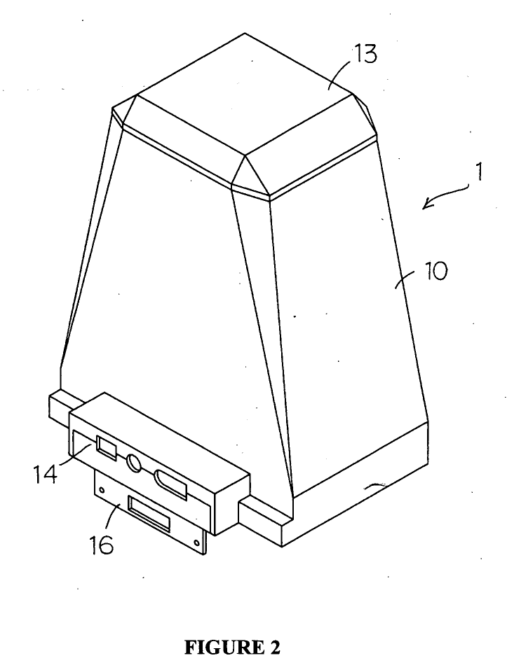

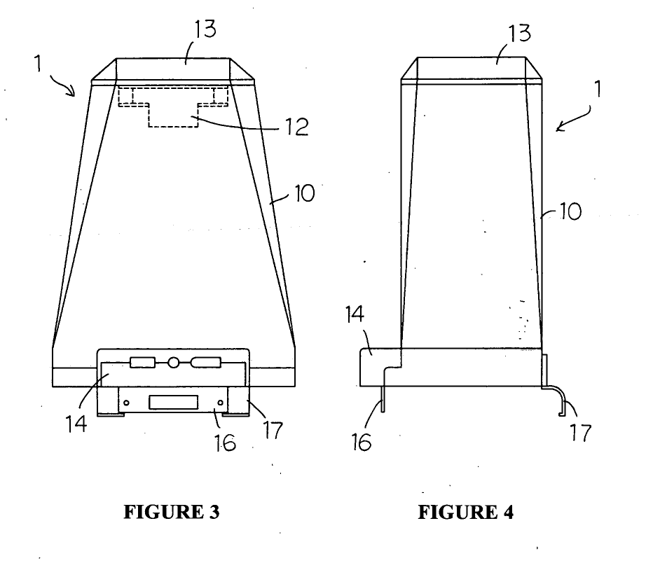

Please refer to FIG. 1 and FIG. 2. The PSP video conversion device (1) for the invention mainly comprises a case (10), which is opaque, hollow and cone-shaped, a holder (11) on top of the case (10) for a camera (12), a cover (13) to hide the camera (12) inside the case (10) and prevent reflection on captured video, a closed holder (14) at one side of the bottom, a control circuit (15) (not shown in the figure) to support the following connections: a power cable, an AV cable and an audio cable, which power cable links to power source, AV cable outputs the integrated AV signal to a large display, audio cable links to the earphone port of the PSP console (2) to capture audio signal, a flat fixing board (16) at the bottom of the holder (14), a curved snap board (17) on the opposite side of the fixing board (16) (as shown in FIG. 3), which fits into top and bottom sides of PSP console (2) to prevent separation, while the fixing board (16) has holes to match the preset holes on PSP console (2) for screws to tighten the device.

The above-mentioned camera (12) can use CMOS module or CCD module.

The above-mentioned control circuit (15) can be programmable IC, possessing the function to convert and output the captured video from PSP console (2) and integrate the video signal with the audio signal captured from the earphone port on PSP console (2) into a synthesized signal acceptable by a large display and output the synthesized signal to a large display (like TV, computer screen).

The above is a brief description about the components and their functions for the present invention. The following will describe the operational principle and expected performance for the invention:

In application, the PSP video conversion device (1) is to combine with PSP console first through the fixing board (16) and the snap board (17). The bottom of the device covers the entire PSP screen and is secured through screws. Thus, the video on PSP LCD screen can be captured by the camera (12) and the audio signal can be captured through the connection of an audio cable to the earphone port. The control circuit (15) then converts and integrates the signals to be accepted by a large display (like TV and computer screen). Then through AV cable, the signals are output to a large display. In such way, the PSP video conversion device (1) converts the video on PSP LCD screen and outputs the signals to a large display. Further, this simple device adds entertaining effect during the gaming process. The audio and video on a large display also create tremendous reality effect and fun to the game player. Further, the device prevents fatigue and vision reduction for eyes.

In summary, the PSP video conversion device possesses advanced functions and practical Value. After extensive research, no such technology is found to be published before. The invention meets the requirements for a patent application based on a new type of product.

### SPECIFIC DRAWING

(1) The designated diagram for the invention is FIG. 1.

(2) The legends in the figure for the invention are described as below:

| | | | |
|---|---|---|---|
| PSP video conversion device | (1) | case | (10) |
| holder | (11) | camera | (12) |
| cover | (13) | holder | (14) |
| fixing plate | (16) | | |

### BRIEF DESCRIPTION OF THE DRAWINGS

FIG. 1 is a preferred embodiment for the invention.

FIG. 2 is an assembly diagram for a preferred embodiment for the invention.

FIG. 3 is a side view for a preferred embodiment for the invention.

FIG. 4 is another side view for a preferred embodiment for the invention.

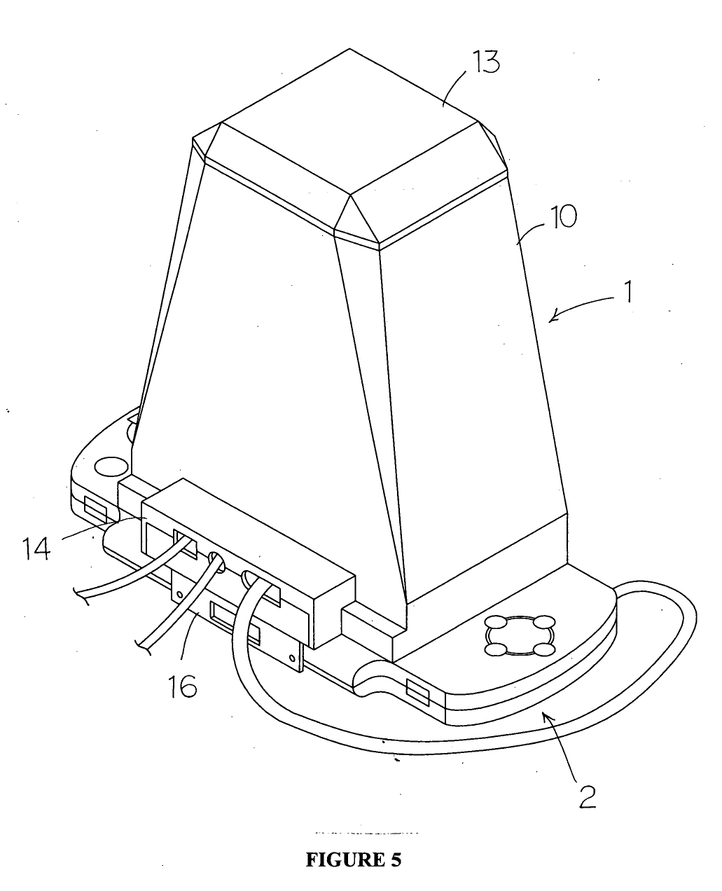

FIG. 5 is a status of use for a preferred embodiment for the invention.

### DESCRIPTION OF MIN COMPONENTS

| | | | |
|---|---|---|---|
| PSP video conversion device | (1) | case | (10) |
| holder | (11) | camera | (12) |
| cover | (13) | holder | (14) |
| Control circuit | (15) | Fixing board | (16) |
| Snap board | (17) | PSP console | (2) |

What is claimed is:

1. A PSP video conversion device mainly comprises a case, a holder on top of the case for a camera, a cover to hide the camera inside the case, a closed holder at one side of the bottom, a control circuit to support the following connections: a power cable, an AV cable and an audio cable, a flat fixing board at the bottom of the holder, a curved snap board on the opposite side of the fixing board, which fits into top and bottom sides of PSP console. Thus, the device is able to convert the video on PSP LCD screen onto a large display.

2. As described in claim 1 for a PSP video conversion device, the case is opaque, hollow and cone-shaped.

3. As described in claim 1 for a PSP video conversion device, the camera uses a CMOS module or a CCD module.

4. As described in claim 1 for a PSP video conversion device, there are holes on the fixing board to match the preset holes on PSP console for screws to secure the attachment.

5. As described in claim 1 for a PSP video conversion device, the audio cable is to capture the audio signal from the earphone port on PSP console.
